(19) United States
(12) Patent Application Publication
(10) Pub. No.: US 2012/0331532 A1
(43) Pub. Date: Dec. 27, 2012

(54) DEVICE-AGNOSTIC MOBILE DEVICE THIN CLIENT COMPUTING METHODS AND APPARATUS

(75) Inventors: Ryan D. Walters, Falls Church, VA (US); Rodney D. Caudle, Kansas City, MO (US); Timothy L. Decamp, Vienna, VA (US)

(73) Assignee: TerraWi, Inc., Falls Church, VA (US)

(21) Appl. No.: 13/166,225

(22) Filed: Jun. 22, 2011

(51) Int. Cl. G06F 21/00; G06F 15/16

(52) U.S. Cl. 726/5; 726/3; 709/206

(57) ABSTRACT

In some embodiments, a non-transitory processor-readable medium stores code representing instructions configured to cause a processor to send, from a sole application stored at a mobile device, a first signal including authentication information of a user. The code can further represent instructions configured to cause the processor to receive, at the sole application, a second signal indicating a set of cloud-based applications associated with the user, the second signal being sent in response to the authentication information. The code can further represent instructions configured to cause the processor to send, to a display of the mobile device, an indicator of the set of cloud-based applications associated with the user, and receive user input including a request to initialize a first cloud-based application from the set of cloud-based applications. The code can further represent instructions configured cause the processor to send a third signal indicating a requested function associated with the first cloud-based application, and receive, in response to the third signal, a fourth signal including information associated with the requested function.

### BACKGROUND

Some embodiments described herein relate generally to thin-client computing, and more particularly to methods and apparatus for device-agnostic thin-client computing using a mobile device.

As use of smartphones and other mobile computing devices has proliferated in the developed world, many users have accordingly increased the breadth and depth of personal and other sensitive information stored on such devices. For example, many users currently store, at such a mobile computing device, personal contact information, messages and other private communications, media libraries, personal and business documents, multiple downloaded applications, and other important information. Given this tendency, the loss, theft, or destruction of such a mobile computing device often results in a catastrophic loss of information, much of which is stored only at the mobile device. When a mobile device is stolen, a user also risks breach of his or her personal, financial and/or other highly-sensitive information. Further, when a user of a mobile device wishes to change to a new mobile device (due to a new employment situation, desire to upgrade, etc.), this information is typically transferred from the previous mobile device to the new mobile computing device in a tedious, time-consuming and often-imprecise process.

Thus, a need exists for methods and apparatus to store mobile device information (e.g., contact information, messages, media, etc.) in and/or execute mobile device applications at one or more remote storage devices included in a private network, whereby loss of an individual mobile device results in none of the above-described inconveniences and/or risks.

### SUMMARY

In some embodiments, a non-transitory processor-readable medium stores code representing instructions configured to cause a processor to send, from a sole application stored at a mobile device, a first signal including authentication information of a user. The code can further represent instructions configured to cause the processor to receive, at the sole application, a second signal indicating a set of cloud-based applications associated with the user, the second signal being sent in response to the authentication information. The code can further represent instructions configured to cause the processor to send, to a display of the mobile device, an indicator of the set of cloud-based applications associated with the user, and receive user input including a request to initialize a first cloud-based application from the set of cloud-based applications. The code can further represent instructions configured cause the processor to send a third signal indicating a requested function associated with the first cloud-based application, and receive, in response to the third signal, a fourth signal including information associated with the requested function.

### BRIEF DESCRIPTION OF THE FIGURES

FIG. 1 is a schematic block diagram that illustrates a mobile thin-client computing platform, according to an embodiment.

FIG. 2 is a schematic diagram that illustrates a mobile device having multiple hardware components and storing a single thin client software module, according to another embodiment.

FIG. 3 is a schematic diagram that illustrates an access server storing an authentication module and a permissions module, according to another embodiment.

FIG. 4 is a schematic block diagram that illustrates a thin client authentication and application execution process, according to another embodiment.

FIG. 5 is a flow chart describing a method of providing cloud-based functionality to a thin client of a mobile device, according to another embodiment.

### DETAILED DESCRIPTION

In some embodiments, a sole application executing at a mobile device can send, to a network server, a request for one or more cloud-based applications associated with the mobile device and/or a user thereof. The mobile device can be, for example, a cellular telephone (e.g., a smartphone), a tablet computing device, a laptop, notebook, or netbook computer, etc. In some embodiments, the mobile device can include the request in one or more signals sent to an access server of the private network via a public wireless network (e.g., a commercial cellular telephone network, a commercial wireless broadband network, etc.). The sole application can be, for example, a firmware and/or software application pre-installed on the mobile device and configured such that no other native firmware and/or software modules or applications can be installed by a user of the mobile device. In this manner, the sole application can be the lone means through which the mobile device can receive and/or send information, including personal data and/or application files/libraries. The access server can be and/or include one or more hardware modules and/or software modules (stored and/or executing in hardware) configured to regulate access of client devices to resources included in or associated with the private network. The private network can be a local area network (LAN), wide area network (WAN), intranet, extranet, etc., associated with a given entity or entities. The private network can optionally include one or more databases, application servers, routers, switches, and/or the like.

In response to the access request received from the mobile device, the access server can (1) determine whether a user of the mobile device is a valid user of the private network (i.e., whether the user is associated with a valid user account registered with/recorded within an element of the private network), and/or (2) determine a set of one or more cloud-based applications accessible by the user account. The access server can accordingly send a response signal to the mobile device including one or more user interface (UI) components, each UI component being associated with a cloud-based application from the set of cloud-based applications associated with the user account. The one or more UI components can be, for example, application icons, titles, descriptions, screen shots, etc.

Upon receipt of the one or more UI components, the mobile device (via, e.g., the sole application) can optionally output, at a display thereof and/or coupled thereto, the one or UI components. In this manner, the mobile device can provide a menu of available/accessible cloud-based applications for selection of and/or use by the user of the mobile device.

The mobile device can next receive a user input signal configured to select for execution one cloud-based application from the set of cloud-based applications accessible by the user. The input signal can be, for example, a touchscreen tap (i.e., a finger or stylus tap), a button click, a voice command, etc. In response to this received input signal, the mobile device can output, at a display device included in or operatively coupled to the mobile device, one or more user interface (UI) elements associated with the selected cloud-based application. In some embodiments, the one or more UI elements can be displayed via or within the sole application. In some embodiments, the mobile device can receive the one or more UI elements from, for example, a network server (e.g., a cloud-based application server) at which the cloud-based application is executing, be it prior to receipt of the input signal or in response thereto. In some embodiments, the mobile device can send, to the network server, a signal including a request to commence execution of the selected cloud-based application at the network server. In this manner, the cloud-based application can be initialized for execution at the network server and for user interaction (i.e., input/output) via a user interface of the mobile device.

In some embodiments, the mobile device can provide user interaction with the executing cloud-based mobile application by receiving one or more user input commands, sending a signal(s) to the network server including an indication of the same, and subsequently/responsively receiving one or more results/responses from the network server for presentation at or via the UI of the executing cloud-based mobile application at a display of the mobile device. In this manner, the mobile device can, in conjunction with the network server, provide functionality of the cloud-based application to a user of the mobile device.

Upon receipt of a user input command indicating a termination of the cloud-based mobile application, the mobile device can 1) close and/or terminate any open/displayed UI components of the cloud-based mobile application, and/or 2) send, to the network server, an indication that the execution of the cloud-based application is to be terminated. In some embodiments, upon receipt of this termination input command, the mobile device can delete a portion of or all information associated with the cloud-based mobile application, all user session information associated with the current user interaction with the cloud-based mobile application, and/or other information based thereon.

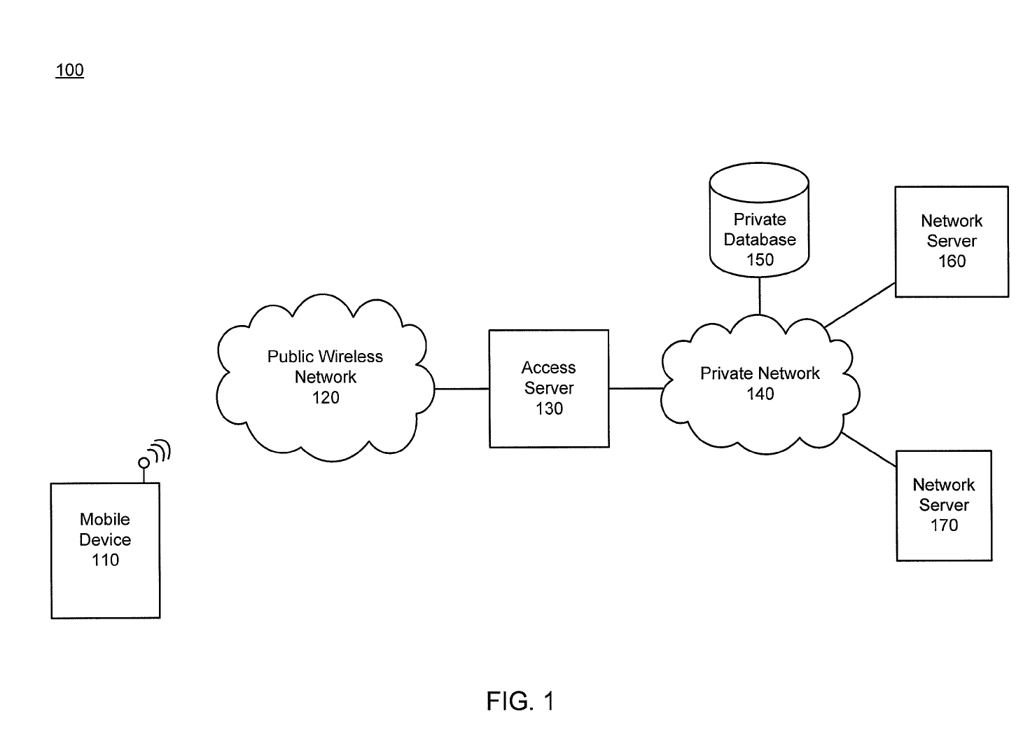

FIG. 1 is a schematic block diagram that illustrates a mobile thin-client computing system, according to an embodiment. More specifically, FIG. 1 illustrates a mobile thin-client computing system 100 that includes a mobile device 110 operatively coupled to an access server 130 via a public wireless network 120. The access server 130 is in communication with a private network 140, which includes and/or is physically and/or operatively coupled to each of a private database 150, a network server 160 and a network server 170.

The mobile device 110 can be any valid mobile computing device capable of exchanging information with the private network 140 via the public wireless network 120 and rendering results and/or user interface (UI) components associated therewith. For example, the mobile device 110 can be a mobile telephone (e.g., a cellular telephone, a smartphone, a satellite telephone) and/or other mobile computing device (e.g., a tablet computing device, a personal digital assistant (PDA), etc.). Although not shown in FIG. 1, the mobile device 110 can have or include one or more antennae and/or network cards (e.g., cellular network communication cards, wireless Ethernet cards, etc.) configured to enable the mobile device 110 to exchange information via one or more wireless networks, such as the public wireless network 120. Although also not shown in FIG. 1, the mobile device 110 can have or include one or more hardware and/or software modules configured to determine a current geolocation of the mobile device 110. For example, the mobile device 110 can have, include and/or be coupled to one or more Global Positioning System (GPS) modules and/or other geolocation modules capable of communicating with one or more GPS satellites, cellular network towers, etc. (not shown in FIG. 1) to determine a current geolocation of the mobile device 110. In some embodiments, the mobile device 110 can include, be operatively coupled to, and/or be physically coupled to one or more input devices and/or peripheral devices (e.g., a display, a touchscreen, a keypad or keyboard, a pointer device, a stylus, etc.). Although not shown in FIG. 1, in some embodiments, multiple mobile devices, similar to the mobile device 110, can be operatively coupled (e.g., wirelessly coupled) to the public wireless network 120, and/or to one or more elements of the private network 140 (via the public wireless network 120).

The public wireless network 120 can be any public wireless network configured to allow two or more client, server, peripheral or other devices to exchange data wirelessly. For example, the public wireless network 120 can be a cellular telephone and/or data network (e.g., a wireless broadband network) configured to transmit data according to any of the Global System for Mobile (GSM), GSM/General Packet Radio Service (GPRS), GSM Enhanced Data Rates for GSM Evolution (EDGE), Code Division Multiple Access (CDMA), CDMA2000, WCDMA (Wideband CDMA), Time Division Multiple Access (TDMA), IEEE 802.11x (“Wi-Fi”), 802.16x (“WiMax”), and/or Long Term Evolution (LTE) standards, and/or one or more other similar standards or protocols. In some embodiments, the public wireless network 120 can be associated with one or more public or private wireless network providers or administrators. For example, the public wireless network 120 can be associated with, constructed, configured and/or administered by a consumer cellular telephone entity, a wireless data provider (e.g., a wireless broadband provider), an Internet Service Provider (ISP), a governmental agency, etc.

The access server 130 can be any combination of hardware and/or software (stored and/or executing in hardware) configured to (1) authenticate a user of the mobile device 110, and (2) grant or deny access to one or more cloud-based applications and/or network resources requested by the mobile device 110 based at least in part on access permissions associated with the mobile device 110 and/or a user thereof (i.e., a user account of said user). Said differently, the access server 130 can be any device configured to receive requests to access one or more resources, functions, or elements of the private network 140 and grant such access only to requesting user accounts associated with an access level, user role, user group, or other access setting associated with requested cloud-based applications and/or other network resources. In some embodiments, the access server 130 can be configured to grant full access to the private network 140 to authenticated users, and to grant limited access to the private network 140 to unauthenticated users and/or other individuals.

In some embodiments, the access server 130 can include one or more network cards (not shown in FIG. 1), such as one or more Ethernet, Fibre Channel, or other network cards configured to exchange packets, cells and/or other data package formats. As shown in FIG. 1, the access server 130 can be physically and/or operatively coupled to each of the public wireless network 120 and the private network 140. In some embodiments, the access server 130 can be situated in a same physical location as one or more elements of the private network 140 (e.g., the private database 150, the network server 160, the network server 170). The access server 130 can also optionally be included in a same physical device or chassis as one or more of the private database 150, the network server 160 and/or the network server 170. Although not shown in FIG. 1, in some embodiments, the functionality of access server 130 can be distributed across two or more physical devices, each physically and/or operatively coupled to the private network 140 and the public wireless network 120. In some embodiments, the mobile thin-client computing system 100 can include multiple access servers similar to the access server 130, thereby providing multiple points of access to the private network 140 and/or one or more elements thereof or resources stored thereat. Although shown in FIG. 1 as a single device, in some embodiments functionality of the access server 130 can be included in one or more devices or elements of the private network 140. For example, one or more of the database 150, the network server 160, or the network server 170 can include access filtering functionality, such that a client device (e.g., the mobile device 110) can directly access a requested device or element when authorized by that device or element.

The private network 140 can be any private network configured to allow two or more client and/or server devices to exchange information to a restricted set of devices and/or users. For example, the private network 140 can be a local area network (LAN), a wide area network (WAN), an intranet, an extranet, or other private network type. In some embodiments, the private network 140 can include and/or be physically coupled and/or operatively coupled to one or more client, server and/or networking devices (e.g., client desktop computers, client mobile devices, database servers, rack-mounted servers, storage area network (SAN) devices, network switches, network routers, etc.) (not shown in FIG. 1). As shown in FIG. 1, the private network 140 can include or be operatively coupled to the access server 130, the private database 150, the network server 160, and the network server 170. Although not shown in FIG. 1, access to the private network 140 (and/or one or more resources thereof) can be restricted based on one or more rules and/or requirements. More specifically, access to the private network 140 (and/or one or more resources thereof) can be managed by the access server 130, which can administer one or more authentication, validation and/or other policies designed to restrict access to the private network 140 based at least in part on, for example, permissions associated with a requesting user account, a current geolocation of a requesting device (e.g., the mobile device 110), etc.

The private database 150 can be any device (e.g., a network server) storing one or more databases. As shown in FIG. 1, the private database 150 can be operatively coupled to the access server 130, the network server 160 and the network server 170 via the private network 140. Although not shown in FIG. 1, in some embodiments, the private network 140 can be coupled to and/or include multiple private databases similar to the private database 150. In some embodiments, the private database 150 can include one or more relational databases including one or more relational database tables. For example, the private database 150 can include one or more Oracle, Microsoft SQL Server, MySQL, PostgreSQL, Informix and/or other databases storing contact, messaging, document, multimedia, permissions, credentials, access history, and/or other data associated with a user of the mobile device 110 and/or the mobile device 110 itself. Although not shown in FIG. 1, the private database 150 can store information accessible only to devices authorized and validated for interaction with the private network 140. In some embodiments, the private database 150 can store some information accessible only to authenticated users, and can store other information accessible to unauthenticated users and/or other individuals. In some embodiments, access to one or more databases, database tables, database columns and/or database rows of the private database 150 can be restricted, by the access server 130, to users and/or devices conforming to a predetermined set of requirements and/or having a predetermined configuration and/or set of credentials. More specifically, access to any of the above-described network resources can be restricted to one or more user accounts associated therewith.

The network server 160 and the network server 170 can be any combination of hardware and/or software configured to provide resources to client devices accessing the private network 140. As shown in FIG. 1, the network server 160 and the network server 170 can be operatively coupled to the private database 150, to the access server 130, and to one another via the private network 140. Although not shown in FIG. 1, in some embodiments, the private network 140 can include fewer or more than two network servers similar to the network servers 160 and 170. Each of the network servers 160 and 170 can optionally be or include a cloud application server configured to store and execute one or more network applications or services (e.g., cloud-based applications, server-side applications, etc.) for access by and/or interaction with the mobile device 110. For example, the network server 160 can execute an e-mail, productivity (e.g., contacts, calendar, word-processing), or other application for access by the mobile device 110 via the public wireless network 120 and the private network 140. Alternatively or additionally, the network server 170 can host an imaging, image-editing, data management, or other cloud-based application or applications. In some embodiments, any or all of the above-described applications can perform one or more commands in response to a request and/or instruction received from a user of a client device (e.g., the mobile device 110) via the private network 140. In such embodiments, each such command can be associated with a predetermined client device or set of client devices, a predetermined access level or group, a predetermined user or set of users, and/or a predetermined geographic region or area. In this manner, the access server 130 and the network servers 160 and 170 can restrict execution of one or more application commands to predetermined contexts and/or scenarios.

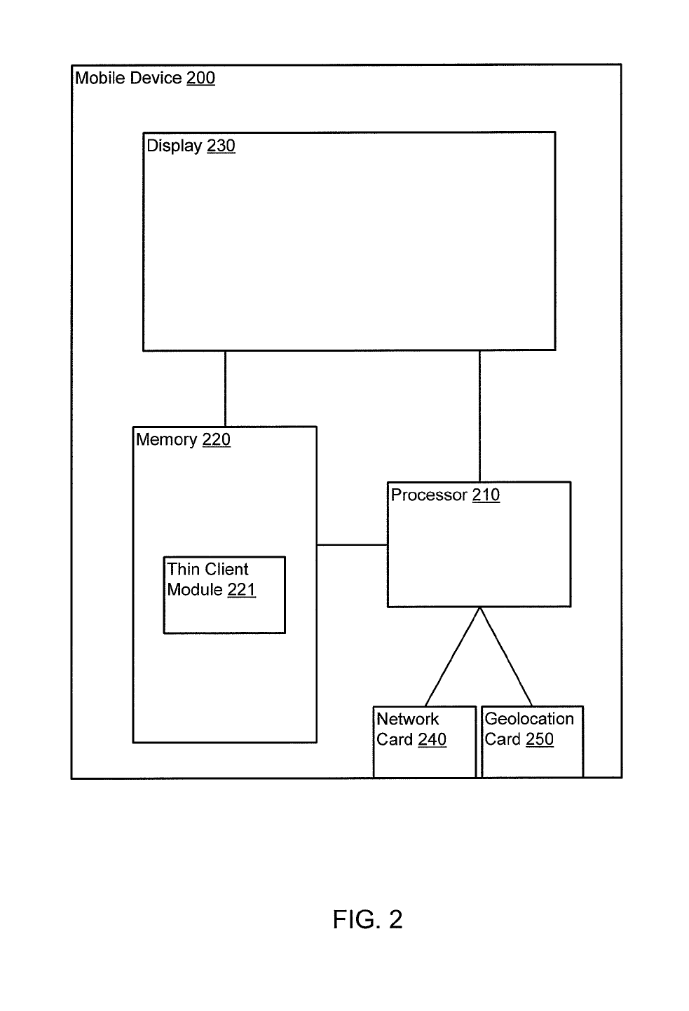

FIG. 2 is a schematic diagram that illustrates a mobile device having multiple hardware components and storing a single thin client software module, according to another embodiment. More specifically, FIG. 2 is a system block diagram of a mobile device 200, similar to the mobile devices 110 described in connection with FIG. 1 above. The mobile device 200 includes a processor 210 operatively coupled to a memory 220, to a display 230, to a network card 240 and, optionally, to a geolocation card 250. As shown in FIG. 2, the memory 220 includes a single software module: the thin client module 221. In some embodiments, the mobile device 200 can include additional hardware modules and/or software modules (stored and/or executing in hardware or stored in memory) not shown in FIG. 2. For example, the mobile device 200 can include one or more input devices and/or peripherals, one or more data input ports, etc.

The processor 210 can be any processor (e.g., a central processing unit (CPU), an application-specific integrated circuit (ASIC), and/or a field programmable gate array (FPGA)) configured to execute one or more instructions received from, for example, the memory 220. In some embodiments, the processor 210 can be a mobile device microprocessor specifically designed to execute on or within a mobile device (e.g., Reduced Instruction Set computing (RISC) processor). As shown in FIG. 2, the processor 210 can be in communication with any of the memory 220, the display 230 and the network card 240. In some embodiments, the processor 210 can accordingly send information (e.g., data, instructions and/or network data packets) to and/or receive information from any of the memory 220, the display 230 and the network card 240.

The memory 220 can be any memory (e.g., a RAM, a ROM, a hard disk drive, an optical drive, other removable media) configured to store information (e.g., a mobile operating system, one or more software applications, media content, text content, contact information, etc.). As shown in FIG. 2, the memory 220 can include a single software module, the thin client module 221. In some embodiments, the memory 220 can include instructions (e.g., code) sufficient to define and/or execute the thin client module 221.

In some embodiments, the thin client module 221 can be a mobile device application configured to provide and/or present one or more cloud-based applications currently being executed remotely at, for example, a network server (e.g., the network server 160 or the network server 170 of FIG. 1). The thin client module 221 can be a sole application installed on/at the mobile device 200, and can be, for example, a firmware and/or software application pre-installed on the mobile device 200 and configured such that no other native firmware and/or software modules or applications can be installed by a user of the mobile device 200. In this manner, the thin client module 221 can be the lone means through which the mobile device 200 can receive and/or send information, including personal data and/or application files/libraries. As such, the thin client module 221 can, as described below, be configured to receive user input signals from a user of the mobile device 200 and exchange information with a remote application server such that one or more cloud-based mobile applications is presented for interaction with/use by that user of the mobile device 200.

For example, the thin client module 221 can communicate (i.e., exchange one or more signals) with a network server included in a private network. Based at least in part on this communication, the thin client module 221 can receive UI components (e.g., icons, titles, text descriptions, etc.) associated with a set of cloud-based applications available to/accessible by a current user of the mobile device 200 (i.e., a user account of the current user). In some embodiments, the thin client module can output, at the display 230, the received UI components. In response to user input indicating a selection of a cloud-based application, the thin client module 221 can launch an initial user interface of the selected cloud-based application and/or send a signal to the network server requesting additional UI components associated with execution of the selected cloud-based application. In some embodiments, the thin client module 221 can retrieve, from the memory 220, at least a portion of the additional UI components. Based at least in part on the additional UI components associated with the selected cloud-based application, the thin client module 221 can initialize the user interface of the cloud-based application at the display 230.

Upon completion of this initialization process, the thin client module 221 can provide input/output functionality for the executing cloud-based application. For example, the thin client module 221 can send one or more user input signals and/or receive one or more output signals, values, UI elements, etc. from the network server currently executing the cloud-based application. In this manner, the thin client module 221 can enable a user of the mobile device 200 to use one or more cloud-based application at the mobile device 200. In some embodiments, upon completion/termination of a currently-executing cloud-based application, the thin client module 221 can send a signal to the memory 200 configured to delete, erase and/or expunge selected or all information associated with the cloud-based application and/or the user stored thereat (e.g., information included in a user session associated with the user and the cloud-based application). In some embodiments, the thin client module 221 can delete the above-described information in response to a detected period of inactivity by a user of the mobile device 200 and/or with respect to the thin client module 221. For example, the thin client module 221 can send a signal configured to delete the above-described information from the memory 220 if it determines that ten or more minutes have passed since a most-recent received user input/command. Alternatively, in some embodiments, the thin client module 221 can be configured to delete a portion or all of the above-described information according to a predetermined schedule, e.g., every five minutes, every 30 minutes, etc., regardless of the amount of received user input signals or commands during a given time period. In this manner, the thin client module 221 can ensure that user data (e.g., user personal information, application use data, etc.) is not stored on the mobile device 200 (e.g., in the memory 220) for a significant period of time, and is thus inaccessible to any subsequent and/or unauthorized user of the mobile device 200.

The memory 220 can also alternatively store one or more resources (e.g., software resources such as drivers, code libraries, etc.) (not shown in FIG. 2) associated with the thin client module 221. In some embodiments, the memory 220 can further store device identifier (ID), software module identifier, hardware component ID, current geolocation information, previous geolocation information and/or other information. In such embodiments, the memory 220 can be configured to not store, or to only temporarily store (e.g., for a predetermined amount of time), personal information associated with a user of the mobile device 200 (e.g., personal identification information, mobile device/mobile application usage information, mobile device location information, etc.)

The display 230 can be any display configured to display information to a user of the mobile device 200. For example, the display 230 can be a liquid crystal display (LCD), a light-emitting diode (LED) display, an organic light-emitting diode (OLED) display, a touchscreen, a tactile display, or other screen or display type. As shown in FIG. 2, the display 230 can receive information from the memory 220 and/or the processor 210. Although not shown in FIG. 2, in some embodiments, the display 230 can receive information from the processor 210 and/or the memory 220 via one or more intermediary modules, such as one or more embedded hardware modules (e.g., a video hardware module). In some embodiments, the display 230 can display information associated with the thin client module 221, such as one or more UI components or elements associated with one or more cloud-based applications (e.g., one or more application icons or titles, UI components associated with an executing cloud-based application, etc.)

The network card 240 can be a hardware module (e.g., a wired and/or wireless Ethernet card, a cellular network interface card) configured to transmit information (e.g., data packets, cells, etc.) from and receive information at the mobile device 200. As shown in FIG. 2, the network card 240 can be operatively and/or physically coupled to the processor 210. In this manner, the processor 210 can, via the network card 240, exchange information with one or more other devices via a network (e.g., the public network 120 discussed in connection with FIG. 1 above).

The geolocation card 250 can be a hardware module (e.g., an antenna) configured to exchange signals and/or information with one or more GPS satellites, cellular network towers, etc. to receive and/or determine current spatial coordinates of the mobile device 200. For example, the geolocation card 250 can be a GPS card configured to receive longitude, latitude and/or altitude coordinates indicating a current physical location and/or position of the mobile device 200. In some embodiments, the geolocation card 250 can be configured to determine a current orientation (e.g., a compass direction) of the mobile device 200. In some embodiments, the geolocation card 250 can be configured to transmit the received and/or determined spatial coordinate and/or other geolocation information to the processor 210 and/or to the thin client module 221 via the processor 210.

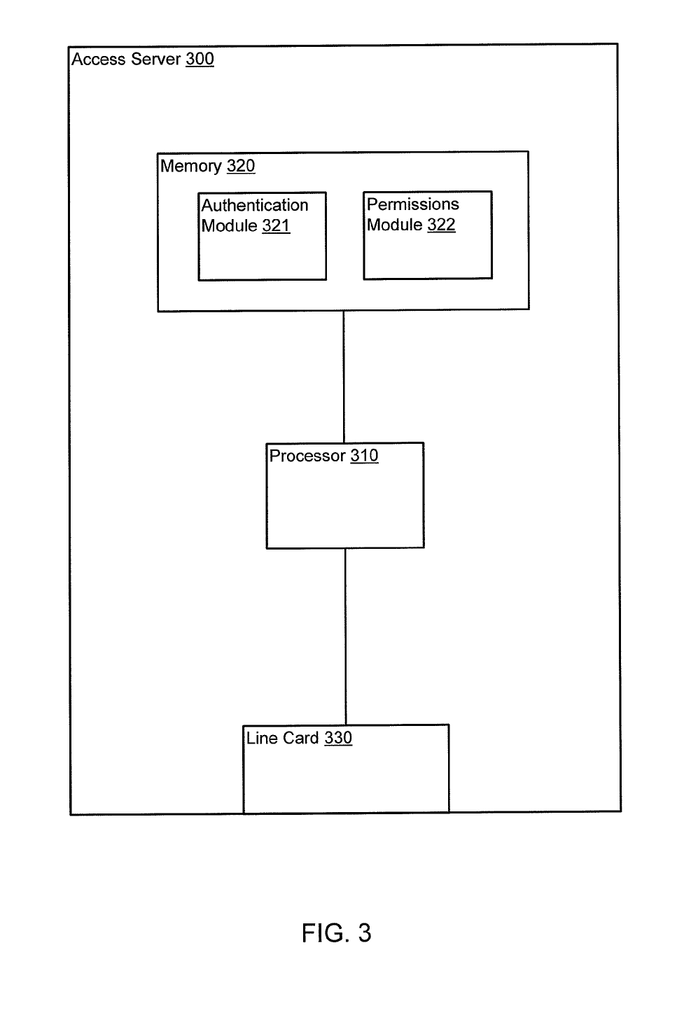

FIG. 3 is a schematic diagram that illustrates an access server storing an authentication module and a permissions module, according to another embodiment. More specifically, FIG. 3 is a system block diagram of an access server 300, similar to the access server 130 described in connection with FIG. 1 above. The access server 300 includes a processor 310 operatively coupled to a memory 320 and to a network card 330. As shown in FIG. 3, the memory 320 includes an authentication module 321 and a permissions module 322. In some embodiments, the access server 300 can include additional hardware modules and/or software modules (stored and/or executing in hardware) not shown in FIG. 3. For example, the access server 300 can include one or more input devices and/or peripherals, one or more data input ports, etc.

The processor 310 can be any processor (e.g., a central processing unit (CPU), an application-specific integrated circuit (ASIC), or a field programmable gate array (FPGA)) configured to execute one or more instructions received from, for example, the memory 320. As shown in FIG. 3, the processor 310 can be in communication with any of the memory 320 and the network card 330. In some embodiments, the processor 310 can accordingly send information (e.g., data, instructions and/or network data packets) to and/or receive information from any of the memory 320 and the network card 330.

The memory 320 can be any memory (e.g., a RAM, a ROM, a hard disk drive, an optical drive, other removable media) configured to store information (e.g., a server operating system, a desktop operating system, one or software applications, etc.). As shown in FIG. 3, the memory 320 can include an authentication module 321 and a permissions module 322. In some embodiments, the memory 320 can include instructions (e.g., code) sufficient to define and/or execute the authentication module 321 and the permissions module 322. The memory 320 can also alternatively store one or more resources (e.g., software resources such as drivers, code libraries, etc.) associated with the authentication module 321 and/or the permissions module 322. In some embodiments, the memory 320 can further store current and/or previous software and/or software/hardware permission information associated with the mobile device.

The authentication module 321 can optionally be a software module configured to determine whether a user of a mobile device is valid, i.e., whether the user should be authorized to access at least a portion of a private network to which the access server 300 is coupled. For example, the authentication module 321 can be configured to receive login and/or other credentials associated with a user of a mobile device and/or a user account associated with the private network. In some embodiments, the credential(s) can be included in a signal received at the access server via a public access network. In some embodiments, the credential(s) can be received from a mobile device requesting access to at least a portion of a private network to which the access server 300 is coupled. Upon receipt of the credentials, the authentication module 321 can determine whether the credentials are associated with a valid user account. To do so, the authentication module 321 can optionally exchange one or more signals with another hardware and/or software module included in the access server 300. Alternatively, the authentication module 321 can exchange one or more signals with a separate device coupled to the private network. The separate device can be, for example, a database (e.g., the private database 150 of FIG. 1) storing login credentials associated with one or more valid user accounts authorized to access the private network.

The permissions module 322 can optionally be a software module configured to determine which cloud-based applications and/or network resources a requesting mobile device and/or user account is authorized to access. The cloud-based applications can include, for example, one or more messaging applications (e.g., e-mail and/or instant messaging applications), one or more productivity applications (e.g., word processor, spreadsheet and/or presentation applications), one or more entertainment applications (e.g., one or more game and/or media applications), etc. The network resources can be, for example, any files, folders, database values, etc. associated with a private network to which the access server 300 is coupled and/or in which the access server 300 is included.

In some embodiments, the permissions module 322 can receive, from a mobile device, a request to be granted access to one or more cloud-based applications and/or network resources with which that mobile device and/or a user thereof is associated. In such embodiments, the permissions module 322 can perform one or more operations to determine which specific cloud-based applications and/or network resources are associated with the user account of a user of the mobile device and/or the mobile device itself. For example, the permissions module 322 can send one or more queries to one or more databases included in the private network, each query optionally based at least in part on an identifier of the user account and/or the mobile device. Based at least in part on a response to the one or more queries, the permissions module 322 can send, to the mobile device, a signal including an indication of the one or more cloud-based applications and/or network resources associated with the user account and/or the mobile device. In some embodiments, the indication can be further based on a current geolocation of the mobile device, as further described in co-pending U.S. Patent Application Docket No. TERR-002/00US 312809-2002 entitled “Multi-layer, Geolocation-based Network Resource Access and Permissions”, which is incorporated herein by reference. The indication can include, for example, one or more titles, filenames, icons and/or other user interface components associated with each of the cloud-based applications and/or network resources.

The network card 330 can be a hardware module (e.g., a wired and/or wireless Ethernet card, a cellular network interface card) configured to transmit information (e.g., data packets, cells, etc.) from and receive information at the access server 300. As shown in FIG. 3, the network card 330 can be operatively and/or physically coupled to the processor 310. In this manner, the processor 310 can, via the network card 330, exchange information with one or more other devices (e.g., a mobile device similar to the mobile device 110 of FIG. 1) via a network (e.g., a network similar to the public wireless network 120 of FIG. 1).

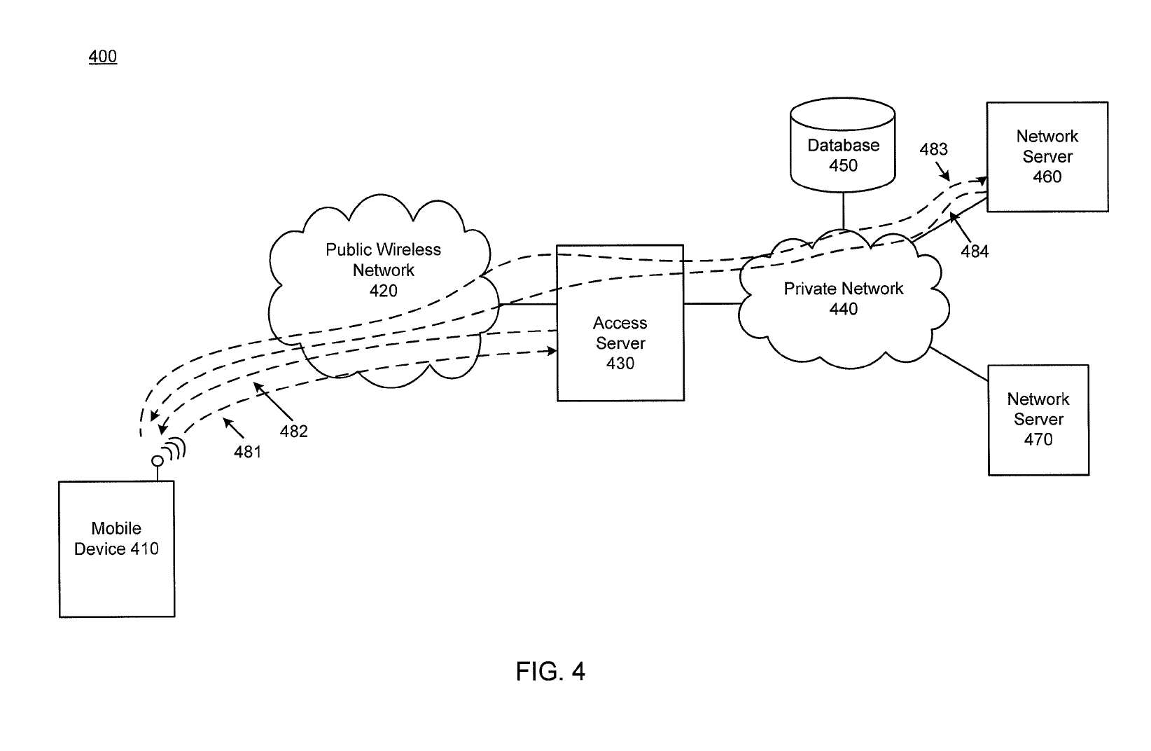

FIG. 4 is a schematic block diagram that illustrates a thin client authentication and application use process, according to another embodiment. More specifically, FIG. 4 illustrates a mobile thin client computing system 400 including a mobile device 410 operatively (e.g., wirelessly) coupled to an access server 430 via a public wireless network 420. The access server 430 can be operatively and/or physically coupled to a private network 440, which can include and/or be coupled to a database 450, a network server 460 and a network server 470. Although not shown in FIG. 4, the private network 440 can include and/or be operatively coupled to multiple databases, network servers and/or other network devices, peripherals or resources.

The mobile device 410 can be any mobile computing device, such as a mobile/cellular telephone, smartphone, tablet computing device, etc. In some embodiments, the mobile device 410 can be substantially similar to the mobile device 110 discussed in connection with FIG. 1 above, and/or to the mobile device 200 discussed in connection with FIG. 2 above. As shown in FIG. 4, the mobile computing device 410 can be operatively coupled to and/or in communication with the access server 430 via the public wireless network 420. As further shown in FIG. 4, when granted access by the access server 430, the mobile device 410 can be in communication and/or can exchange data with one or more of the database 450, the network server 460 and the network server 470.

The public wireless network 420 can be any public cellular, Wi-Fi, WiMax or other wireless data network. In some embodiments, the public wireless network 420 can be substantially similar to the public wireless network 120 discussed in connection with FIG. 1 above.

The access server 430 can be any combination of hardware and/or software configured to regulate access of client devices (e.g., wireless devices such as the mobile device 410) to the private network 440. In some embodiments, the access server 430 can be a single server device, multiple server devices, a distributed service instantiated at multiple server devices, etc. In some embodiments, the access server 430 can be similar to the access server 130 discussed in connection with FIG. 1 above, and/or to the access server 300 discussed in connection with FIG. 3 above. As shown in FIG. 4, the access server 430 can optionally exchange signals and/or data with the mobile device 410 via the public wireless network 420. In some embodiments, the access server 430 can be configured to authorize the mobile device 410 for access to the private network 440 and/or to determine whether the mobile device 410 and/or a user thereof is authorized to access one or more network resources of the private network 440 and/or execute one or more cloud-based applications associated with the private network 440. For example, the access server 430 can receive a request from a sole application executing on a mobile device (e.g., a thin client mobile application executing at the mobile device 410, such as the thin client module 221 described in connection with FIG. 2 above) and send, in response to the request, one or more code portions, executable binary files, icons, descriptions, titles, images and/or the like associated with one or more cloud-based applications accessible by the mobile device and/or a user thereof. In some embodiments, the one or more cloud-based applications can be accessible to a user of a mobile device based at least in part on one or more user credentials associated with a user account of the user and/or one or more user groups, roles, profiles, or other access settings associated with the user account of the user. The one or more cloud-based applications can be or include, for example, a calendars, e-mail, address book, camera, file storage, productivity, instant messaging, multimedia, or other cloud-based application. The private network 440 can be any private LAN, WAN, intranet, extranet or other private computing network associated with one or more entities, organizations, and/or the like. In some embodiments, the private network 440 can be substantially similar to the private network 140 discussed in connection with FIG. 1 above.

The database 450 can be any database or database server included in and/or operatively and/or physically coupled to the private network 440. In some embodiments, the database 450 can be similar to the private database 150 described in connection with FIG. 1 above. The database 450 can optionally store information associated with one or more mobile devices and/or mobile device users (via, e.g., user accounts associated therewith). For example, the database 450 can store information associated with the mobile device 410 and/or a user thereof. In some embodiments, the database 450 can store a device ID of the mobile device 410, a configuration hash value associated with and/or based at least in part on a hardware configuration and/or software configuration of the mobile device 410, etc. In some embodiments, the database 450 can store one or more lists of hardware components, software modules, cloud-based applications, software permissions and/or combinations thereof associated with a given mobile device and/or user. The database 450 can also optionally store credential information associated with one or more users, such as username, password, biometric credential, password question/answer and/or other user authentication information. In this manner, the database 450 can provide the access server 430 with information necessary to (1) authenticate a mobile device and/or user thereof, and (2) determine which network resources, cloud-based applications and the like are accessible by that mobile device and/or the user thereof.

The network servers 460 and 470 can be any combination of hardware and/or software configured to provide the access server 430 and/or a mobile device (e.g., the mobile device 410) with data, services, functionality and/or other network resources or features (e.g., cloud-based applications, commands, etc.). In some embodiments, the network servers 460 and 470 can be similar to the network servers 160 and 170 described in connection with FIG. 1 above. Although not shown in FIG. 4, in some embodiments, any or both of the network servers 460 and 470 can be included in a single physical device as one another and/or another resource or element of the private network 440 (e.g., the access server 430, the database 450).

As shown in FIG. 4, the mobile device 410 can send a signal 481 to the access server 430 via the private wireless network 420. The signal 481 can optionally be sent wirelessly, e.g., via a wireless cellular data and/or computer network. Alternatively, the signal 481 can be sent via one or more other means, e.g., a wired Ethernet or coaxial cable network, a Bluetooth connection, an Ultra Wide Band (UWB) connection, a wireless Universal Serial Bus (wireless USB) connection, an Intel Thunderbolt connection, and/or the like. In some embodiments, the signal 481 can be sent via a trusted (e.g., secure and/or encrypted) or untrusted (e.g., unencrypted) network connection. The signal 481 can include, for example, a request to receive a list and/or other information or indication of a set of cloud-based applications associated with and/or accessible by a user of the mobile device 410. For example, the request can include a request for icons, text descriptions, and/or another indication of a set of cloud-based applications that can be accessed and/or executed by a user of the mobile device 410. In some embodiments, the signal 481 can be sent from a sole application executing at the mobile device 410, such as a thin client mobile device application (e.g., the thin client module 221 described in connection with FIG. 2 above). Alternatively or additionally, the request can include a request to access a specified portion of data (e.g., a file, files, folder, database record, etc.), to execute a command at the network server 460, etc.

In some embodiments, the signal 481 can include authentication credentials associated with a current user of the mobile device 410. The authentication credentials can include, for example, a username and password associated with a user account of the user, and/or a current geolocation of the mobile device 410. Upon receipt of the signal 481, the access server 430 can perform an authentication process associated with the user of the mobile device 410 and/or the mobile device 410 itself. As described in connection with FIG. 3 above, the authentication process can include verification of one or more user credentials by accessing, for example, a database such as the database 450. In some embodiments, the authentication process can include comparison of the current geolocation of the mobile device 410 with one or more geographic regions and/or coordinates associated with the requested one or more network resources.

Based at least in part on the signal 481, the access server 430 can determine a set of cloud-based applications and/or network resources accessible by the user of the mobile device 410. To do so, the access server 430 can access an internal memory and/or send one or more queries to a database associated with the private network 440 (e.g., the database 450). In response, the access server 430 can receive and/or determine the set of cloud-based applications accessible by the user of the mobile device 410 and, optionally, one or more metadata and/or UI elements associated with the same. Having authenticated the user of the mobile device 410 and determined the one or more cloud-based applications that the user of the mobile device 410 is currently authorized to access and/or execute, the access server 430 can send a signal 482 to the mobile device 410 via the public wireless network 420. The signal 482 can include, for example, one or more indications of the set of cloud-based applications, such as titles, descriptions, icons, etc.

Upon receipt of the signal 482, the mobile device 410 can next display, at an output and/or display device included in and/or operatively coupled thereto, an indication at least a portion of the set of cloud-based applications. For example, the mobile device 410 can output, at a screen of the mobile device 410, a set of icons and titles, each icon and corresponding title representing a cloud-based application from the set of cloud-based applications. In some embodiments, each of the icons and/or titles can be UI elements configured to trigger execution of the cloud-based application with which that icon and/or title is associated. In this manner, the mobile device 410 can dynamically present, for selection by the user, a set of cloud-based applications configured to be executed remotely at a network server such as the network server 460.

The mobile device 410 can next receive a user input (not shown in FIG. 4) including a selection of a first cloud-based application from the set of cloud-based application. The user input can be, for example, a tap of an area of a touchscreen included in and/or coupled to the mobile device 410, the area of the touchscreen being associated with a first cloud-based app from the set of cloud-based apps. Alternatively, the user input can be a voice command, keyboard command, stylus tap or gesture, etc.

Based at least in part on the received user input, the mobile device 410 can send a signal 483 to the network server 460 via the public wireless network 420, the access server 430 and the network server 460. In some embodiments, the signal 483 can be sent directly to the network server 460 (and authorized thereat) from the public wireless network 420 (bypassing the access server 430), and/or via one or more routing and/or switching devices included in the private network 440. The signal 483 can include, for example, a request and/or instruction configured to initialize execution of the indicated cloud-based app. In some embodiments, the signal 483 can be sent via a trusted (e.g., secure and/or encrypted) or untrusted (e.g., unencrypted) network connection.

Based at least in part on the signal 483, the network server 460 can commence execution of the cloud-based application. In some embodiments, the network server 460 can send one or more signals to the mobile device 410 configured to cause one or more graphic, UI, text, media and/or other elements to be output at a display of the mobile device 410. For example, as shown in FIG. 4, the network server 460 can send a signal 484 to the mobile device via the private network 440 and the public network 420. Although shown in FIG. 4 as passing through the access server 430, in some embodiments, the signal 484 can bypass the access server 430, and can be sent directly from a routing and/or switching device of the private network 440 to the public wireless network 420, and on to the mobile device 410. (Although not shown in FIG. 4, in some embodiments, any of the signals 481-484 can be sent directly to the private network 440, bypassing the public wireless network 420 entirely.)

Upon receipt of the signal 483, in some embodiments, the mobile device 410 can output, at a display operatively and/or physically coupled thereto, the one or more UI, text, media, graphic, and/or other elements of the cloud-based application included in the signal 483. In some embodiments, the mobile device 410 and the network server 460 can subsequently exchange one or more additional signals (not shown in FIG. 4) so as to present functionality and/or features of the selected cloud-based application to the user at the mobile device 410. For example, the network server 460 can send a storage signal (not shown in FIG. 4) to the mobile device 410 configured to cause the mobile device 410 to store, at a local memory (e.g., a temporary local memory portion associated with a user session), data associated with the cloud-based application. In some embodiments, the network server 460 can send the storage signal via a secure channel (e.g., an encrypted channel, such as a virtual private network (VPN) or other secure connection).

In an example, the mobile device 410 can receive an input signal configured to request any new received e-mail messages associated with a user account of the user. In this example, the mobile device 410 can accordingly send a signal including a request for the new messages to the network server 460 via the public wireless network 420 and the private network 440. In the example, the network server 460 can accordingly query a data store (e.g., the database 450) to determine sender information, subject line information, message body information, message attachment information, etc. associated with one or more new received e-mail messages associated with the user account. Based at least in part on this new message information, the network server 460 can next send a response signal to the mobile device 410. Upon receipt of this response signal, the mobile device 410 can accordingly next display at least a portion of the new message information to the user.

In another example, a second cloud-based application can be a remote file storage application. In the example, the mobile device 410 can send a signal to the network server 460, the subsequent signal being associated with a remote file storage application. The signal can include, for example, an instruction configured to cause the network server 460 to store, at a secure storage location associated with the user of the mobile device 410 (e.g., a storage location associated with a user account of the user), one or more files indicated by the subsequent signal.

In some embodiments, when the user has completed use of the cloud-based application, the mobile device 410 can receive a subsequent input signal from the user (not shown in FIG. 4) and accordingly send a signal (not shown in FIG. 4) configured to cause the network server 460 to terminate the cloud-based application. At this point, the mobile device 410 can optionally delete, expunge, overwrite and/or otherwise discard at least a portion of locally-stored information associated with the cloud-based application. For example, the mobile device 410 can delete or “empty” a the contents of a predetermined memory location and/or portion of an internal memory associated with the set of cloud-based applications and included in the mobile device 410. In some embodiments, the mobile device 410 can delete the above-described information in response to a detected period of inactivity by a user of the mobile device 410 and/or with respect to the cloud-based application. For example, the mobile device 410 can delete the above-described information if it determines that five minutes have passed since a most-recent received user input/command. In another example, the mobile device 410 can delete the above-described information if it detects that a current geolocation of the mobile device 410 has changed, has entered a different predetermined geographic region, has changed by more than a threshold amount/distance, etc. In this manner, the mobile device 410 can temporarily—but not persistently—store information and/or data associated with a mobile device application, such as user session, setting, file, application activity and/or other information.

In some embodiments, the network server 460 can be configured to execute multiple cloud-based applications, associated with multiple mobile devices, at substantially the same time. For example, the network server 460 can execute a first cloud-based application associated with the a first user and the mobile device 410 (as described above), a second cloud-based application associated with the first user and the mobile device 410 and a third cloud-based application associated with a second user and a second mobile device (not shown in FIG. 4). In some embodiments, the network server 460 can subsequently execute a same or different cloud-based application associated with the first user and a third mobile device (not shown in FIG. 4). In this manner, the network server 460 can provide cloud-based application functionality to the first user, independent of the particular mobile device by which the first user accesses the private network 440, the network server 460 and any cloud-based application.

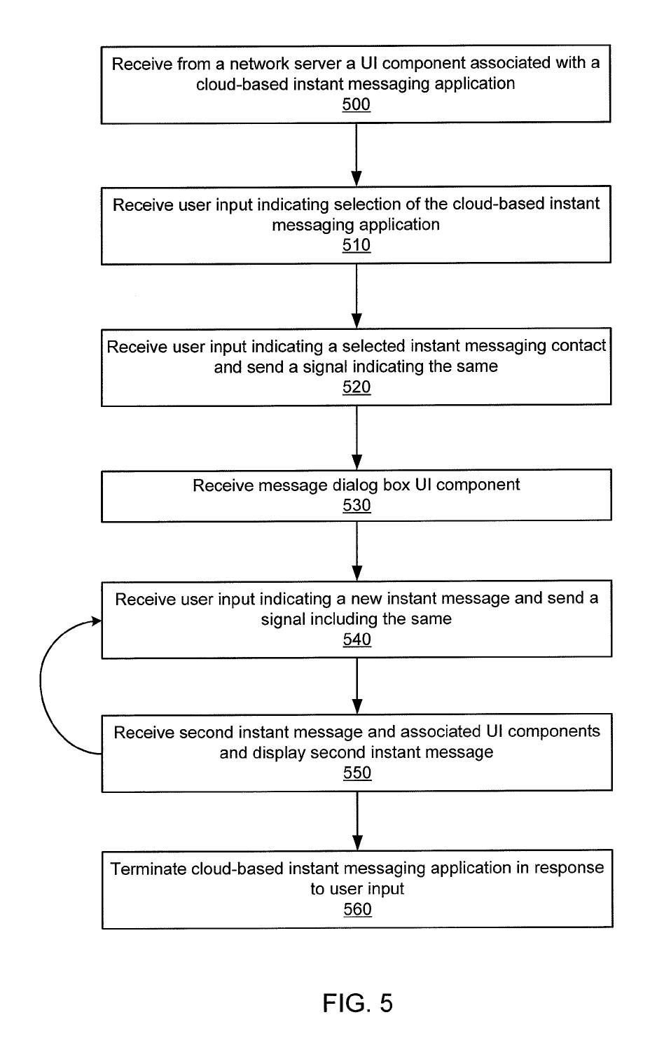

FIG. 5 is a flow chart describing a method of providing cloud-based instant messaging functionality at a mobile device, according to another embodiment. More specifically, FIG. 5 describes a method of receiving an indication of a cloud-based instant messaging application at a mobile device, receiving user input configured to select and initiate the same, and sending and receiving two or more instant messages to/from a selected instant messaging contact via a cloud-based application server.

A mobile device can receive, from a network server (e.g., a cloud application server), a UI component associated with a cloud-based instant messaging application, 500. The mobile device can be any mobile computing and/or communication device configured to exchange data with a public and/or private network, such as a wireless cell phone, data and/or other network. In some embodiments, the mobile device can be substantially similar to the mobile device 210 and/or the mobile device 410 described in connection with FIGS. 2 and 4, respectively. The UI component associated with the cloud-based instant messaging application can be, for example, an application icon file and/or title text. In some embodiments, the mobile device can next output, at a display operatively coupled to or included in the mobile device, UI component associated with the cloud-based instant messaging application. In some embodiments, the mobile device can output one or more additional UI components (e.g., icons and/or titles) associated with multiple other cloud-based applications, thereby providing an indication of a set of cloud-based applications for selection and use by the user. Although described in FIG. 5 as a cloud-based instant messaging application, the cloud-based instant messaging application can alternatively be any cloud-based application capable of being executed at a network device and interacted with remotely at a mobile device in communication therewith. For example, the cloud-based instant messaging application can be a messaging, game, media, file storage, productivity, or other cloud-based mobile application.

The mobile device can receive user input indicating selection of the cloud-based instant messaging application, 510. More specifically, the mobile device can receive, via one or more input modules, peripherals and/or components, a user input signal indicating a selection of the cloud-based instant messaging application. The user input signal can be received via, for example, a touchscreen of the mobile device, a microphone of the mobile device, a button coupled to the mobile device, etc. In some embodiments, the user input signal can be received based at least in part on a user selection (via, for example, a touchscreen tap or button press) of a display icon associated with the cloud-based application. In response to the selection of the cloud-based instant messaging application, the mobile device can display one or more user interface (UI) elements necessary to present, via a display of the mobile device, a user interface of the cloud-based instant messaging application. The one or more user interface elements can include, for example, a command menu, background image, one or more dialog boxes, instructions and/or descriptive text and/or images, etc. In some embodiments, the one or more UI elements can be received from the network server in response to a signal sent thereto by the mobile device indicating selection of the cloud-based instant messaging application (not shown in FIG. 5).

The mobile device can receive further receive user input indicating a selected instant messaging contact and send a signal indicating the same, 520. In some embodiments, the mobile device can receive the user input indicating the instant messaging contact via a voice command spoken into a microphone included in or coupled to the mobile device. Alternatively, the mobile device can receive the user input indicating the instant messaging contact via a tactile or on-screen keyboard. Upon receipt of the user input described above, the mobile device can send, to a cloud-based application server executing the instant messaging application, a signal indicating the selected instant messaging contact.

The mobile device can receive, from the cloud-based application server, a signal including a message dialog box UI component, 530. In some embodiments, the mobile device can accordingly next output the message dialog box UI component at a display. In this manner, the mobile device can provide a user of the mobile device with a means of entering a new instant message for transmission to the selected instant messaging contact.

The mobile device can next receive a set of user input signals including indication of a new instant message and a send instruction, and send a signal including the new instant message, 540. For example, the mobile device can receive, via a tactile and/or on-screen keyboard, one or more indications of alphanumeric characters comprising a new instant message, and an instruction to transmit the new instant message to the selected instant messaging contact. The mobile device can then send, to the cloud-based application server, a signal including the new instant message. In some embodiments, the signal can include the alphanumeric characters described in connection with step 540 above, and can include an indication of the selected instant messaging contact for purposes of transmitting the new instant message.

The mobile device can receive a second instant message and UI components associated therewith, 550. More specifically, the mobile device can receive, from the cloud-based server, a signal including (1) a second instant message received from the cloud-based application server and sent from the selected instant messaging contact and (2) UI components used to display the second instant message at a display. Based at least in part on the received signal, the mobile device can output, at the display of the mobile device, the second instant message and the one or more UI components used to render the same. As shown in FIG. 5, the mobile device can perform the steps 550 and 560 one or more times during the course of an instant message conversation/session between the user and the selected instant messaging contact through the cloud-based application server.

The mobile device can terminate the cloud-based instant message conversation in response to user input, 560. Alternatively, the mobile device can terminate its locally-rendered/executing cloud-based instant messaging components in response to a received signal indicating that the selected instant messaging contact has terminated the instant message conversation. More specifically, the mobile device can close (i.e., remove from the display) the one or more UI components associated with the cloud-based instant messaging application in response to a user close command, received via, for example, a touchscreen, microphone, keyboard, or other input device of or coupled to the mobile device. In some embodiments, the mobile device can send a signal to the cloud-based application server configured to instruct the cloud-based application server to terminate execution of the cloud-based instant messaging application thereat. In some embodiments, the mobile device can send one or more signals configured to delete, from a memory of the mobile device, a portion of or all information associated with the cloud-based instant messaging application, the instant messaging conversation and/or records of interaction of the user with the cloud-based instant messaging conversation (i.e., a user session).

Some embodiments described herein relate to a computer storage product with a computer-readable medium (also can be referred to as a processor-readable medium) having instructions or computer code thereon for performing various computer-implemented operations. The media and computer code (also can be referred to as code) may be those designed and constructed for the specific purpose or purposes. Examples of computer-readable media include, but are not limited to: magnetic storage media such as hard disks, floppy disks, and magnetic tape; optical storage media such as Compact Disc/Digital Video Discs (CD/DVDs), Compact Disc-Read Only Memories (CD-ROMs), and holographic devices; magneto-optical storage media such as optical disks; carrier wave signal processing modules; and hardware devices that are specially configured to store and execute program code, such as Application-Specific Integrated Circuits (ASICs), Programmable Logic Devices (PLDs), and read-only memory (ROM) and RAM devices.

Examples of computer code include, but are not limited to, micro-code or micro-instructions, machine instructions, such as produced by a compiler, code used to produce a web service, and files containing higher-level instructions that are executed by a computer using an interpreter. For example, embodiments may be implemented using Java, C++, or other programming languages (e.g., object-oriented programming languages) and development tools. Additional examples of computer code include, but are not limited to, control signals, encrypted code, and compressed code.

While various embodiments have been described above, it should be understood that they have been presented by way of example only, not limitation, and various changes in form and details may be made. Any portion of the apparatus and/or methods described herein may be combined in any combination, except mutually exclusive combinations. The embodiments described herein can include various combinations and/or sub-combinations of the functions, components and/or features of the different embodiments described. For example, a mobile device validation system can include multiple access servers configured to authenticate one or more mobile device users and/or to validate one or more client mobile devices.

What is claimed is:

1. A non-transitory processor-readable medium storing code representing instructions configured to cause a processor to:
send, from a sole application stored at a mobile device, a first signal including authentication information of a user;
receive, at the sole application, a second signal indicating a set of cloud-based applications associated with the user, the second signal being sent in response to the authentication information;
send, to a display of the mobile device, an indicator of the set of cloud-based applications associated with the user;
receive user input including a request to initialize a first cloud-based application from the set of cloud-based applications;
send a third signal indicating a requested function associated with the first cloud-based application; and
receive, in response to the third signal, a fourth signal including information associated with the requested function.

2. The non-transitory processor-readable medium of claim 1, wherein the code further represents instructions configured to cause the processor to:
send, in response to a termination of the first application, a fifth signal configured to delete, from a memory, all information associated with the user and the first cloud-based application.

3. The non-transitory processor-readable medium of claim 1, wherein the set of cloud-based applications includes at least one of: an address book application, a calendars application, an e-mail application, a camera application, or a file storage application.

4. The non-transitory processor-readable medium of claim 1, wherein the code further represents instructions configured to cause the processor to:
access user interface information associated with the set of cloud-based applications; and
not access functionality information associated with the set of cloud-based applications.

5. The non-transitory processor-readable medium of claim 1, wherein the code further represents instructions configured to cause the processor to:
output, at a display, one or more user interface (UI) components associated with the set of cloud-based applications.

6. The non-transitory processor-readable medium of claim 1, wherein user data associated with the set of cloud-based applications is stored at a predetermined memory location associated with user session data.

7. The non-transitory processor-readable medium of claim 1, wherein the authentication information includes a username, a password, a biometric credential or a geolocation of the mobile device.

8. A non-transitory processor-readable medium storing instructions configured to cause a processor to:
receive, from a first mobile device executing a first mobile operating system, a first signal including authentication information associated with a user;
send, to the first mobile device, based at least in part on the authentication information, a second signal including a first indication of a set of mobile applications associated with the user and a set of application functions associated with the user;
receive, from the first mobile device, a third signal including a request to perform a first application function from the set of application functions;
perform the first application function to produce a first result;
send, to the first mobile device, a fourth signal including the first result;
receive, from a second mobile device executing a second mobile operating system, a fifth signal including the authentication information associated with the user;
send, based at least in part on the authentication information, a sixth signal including a second indication of the set of mobile applications associated with the user and the set of application functions associated with the user;
receive, from the second mobile device, a seventh signal including a request to perform a second application function from the set of application functions;
perform the second application function to produce a second result; and
send, to the second mobile device, an eighth signal including the second result.

9. The non-transitory processor-readable medium of claim 8, wherein the first application function is storage of a file at a secure storage location associated with the user.

10. The non-transitory processor-readable medium of claim 8, wherein the first signal and the fifth signal are received via an untrusted network connection.

11. The non-transitory processor-readable medium of claim 8, wherein the code further represents instructions configured to cause the processor to:
send, to the first mobile device, a ninth signal configured to cause the first mobile device to delete all activity information associated with the first application and associated with the user in response to a termination of the first application.

12. The non-transitory processor-readable medium of claim 8, wherein the code further represents instructions configured to cause the processor to:
send, to a personal computing device, via a secure channel, a ninth signal configured to cause the personal computing device to store information associated with the user and associated with the first application.

13. A non-transitory processor-readable medium storing code representing instructions configured to cause a processor to:
receive, from a server, a first signal including an indication of an instant messaging application associated with a user of a mobile device;
receive, from the user, a user input signal including a selected instant messaging contact;
send a second signal including a first instant message for transmission to a device associated with the selected instant messaging contact;
receive a third signal including a second instant message sent from the device associated with the selected instant messaging contact; and
delete, from a memory operatively coupled to the processor, a record including the first instant message.

14. The non-transitory processor-readable medium of claim 13, wherein the code further represents instructions configured to cause the processor to:
send, for storage at the server, a fourth signal including the first instant message and the second instant message.

15. The non-transitory processor-readable medium of claim 13, wherein the user input signal is a first user input signal, and the code further represents instructions configured to cause the processor to:
receive, from the user, a second user input signal indicating a selection of the instant messaging application.

16. The non-transitory processor-readable medium of claim 13, wherein the code further represents instructions configured to cause the processor to:
delete, from the processor-readable medium, the indication of the instant messaging application.

17. The non-transitory processor-readable medium of claim 13, wherein the code further represents instructions configured to cause the processor to:
send, to the server, an authentication credential associated with the user; and
receive, from the server, an indication of a set of cloud-based applications associated with the user, the indication of the set of cloud-based applications including the indication of the instant messaging application.

18. The non-transitory processor-readable medium of claim 13, wherein the code further represents instructions configured to cause the processor to:
receive, from the server, a fourth signal indicating a set of authorized functions associated with the user, the set of authorized functions including an instant messaging function.

19. The non-transitory processor-readable medium of claim 13, wherein the second signal and the third signal are sent to the server.

20. The non-transitory processor-readable medium of claim 13, wherein the third signal includes a user interface component associated with the second instant message.
